(19) United States
(12) Patent Application Publication
(10) Pub. No.: US 2006/0010295 A1
(43) Pub. Date: Jan. 12, 2006

(54) Distributed storage for disk caching

(75) Inventors: Peter A. Franaszek, Mount Kisco, NY (US); Dan E. Poff, Mahopac, NY (US)

Correspondence Address: Frank Chau, Esq.;F. CHAU & ASSOCIATES, LLC, 130 Woodbury Road, Woodbury, NY, 11797, US

(73) Assignee: International Business Machines Corporation

(21) Appl. No.: 10/887,420

(22) Filed: Jul. 8, 2004

(51) Int. Cl. G06F 12/00

(52) U.S. Cl. 711/138; 711/114; 711/113

(57) ABSTRACT

We separate the control functions of the I/O from the actual caching and transfer of data. This is referred herein as “disk improvements.” For caching, this enables improved utilization of bandwidth and memory. For transfers of data, bandwidth is improved while retaining security. Also in the present invention, we utilize unused portions of host systems to serve as a cache. This is referred herein as “cache enhancements.”

### BACKGROUND OF THE INVENTION

1. Field of the Invention

The present invention relates to computer storage management, and, more particularly, distributed storage for disk caching.

2. Description of the Related Art

A typical virtualization engine (“VE”) acts as an intermediary between one or more host systems (“HS”) and a centralized disk subsystem (hereinafter “disk”). A primary purpose of the VE is to virtualize the disk, and a secondary purpose is to provide security for accessing the disk. For example, a particular HS may have access to only certain portions of the disk and not to other portions.

The HS generally sends a data request to the VE for performing a read/write from/to the disk. A data request for a read may include a virtual disk address, which provides the location on the disk from which data is retrieved. A data request for a write may include data and a virtual disk address, which provides a location on the disk on which data is written. The VE stores the data request on a VE cache, and performs the read or write. The disk may also include a disk cache for storing recently referenced data. The host system may utilize two virtualization engines for purposes of fault tolerance.

Although current VE systems can be quite effective, they have some potential drawbacks because all input/output (“I/O”) is performed through the VE. Thus, a bottleneck may occur in a VE servicing numerous requests for a plurality of disks. In some systems, for example, blade servers, the bandwidth between neighboring HSs on the same rack may be substantially higher than that between HSs on different racks. Further, memory capacity for the VE may be restricted by physical limitations. Also, there may be HSs with underutilized memory.

### SUMMARY OF THE INVENTION

In one aspect of the present invention, a distributed storage system for caching is provided. The distributed storage system for caching includes a host system; a virtualization engine operatively connected to the host system; and a disk subsystem operatively connected to the virtualization engine and the host system; wherein the virtualization engine virtualizes the disk subsystem and validates a request to access the disk subsystem sent by the host system to the virtualization engine; and wherein, if the request is validated, the virtualization engine sends instructions to the disk subsystem to complete the request directly with the host system, bypassing the virtualization engine.

In another aspect of the present invention, a distributed storage system for caching is provided. The distributed storage system for caching includes a first host system; a second host system, the second host system comprising a second host system cache; a virtualization engine operatively connected to the first host system and the second host system; and a disk subsystem operatively connected to the virtualization engine, the first host system, and the second host system; wherein the virtualization engine virtualizes the disk subsystem and validates an I/O request to access the disk subsystem sent by the first host system to the virtualization engine; wherein the virtualization engine determines whether the second host system cache comprises data to fulfill the I/O request; and wherein, if the I/O request is validated and the second host system cache comprises data to fulfill the I/O request, the virtualization engine sends instructions to the second host system to complete the I/O request directly with the first host system, bypassing the virtualization engine.

In yet another aspect of the present invention, a distributed storage system for caching is provided. The distributed storage system for caching includes a host system; a virtualization engine operatively connected to the host system, the virtualization engine comprising a virtualization engine cache; and a disk subsystem operatively connected to the virtualization engine and the host system; wherein the virtualization engine virtualizes the disk subsystem and validates an I/O request to access the disk subsystem sent by the host system to the virtualization engine, the I/O request comprising a read request; wherein, if the read request is validated and requested data is found in a virtualization engine cache, the virtualization engine cache transfers the requested data directly to the host system; and wherein, if the read request is validated and the requested data is absent in the virtualization engine cache, the virtualization engine sends instructions to the disk subsystem to transfer the requested data directly to the host system, bypassing the virtualization engine.

In a further aspect of the present invention, a distributed storage system for caching is provided. The distributed storage system for caching includes a first host system; a second host system, the second host system comprising a second host system cache; a virtualization engine operatively connected to the first host system and the second host system; and a disk subsystem operatively connected to the virtualization engine, the first host system, and the second host system; wherein the virtualization engine virtualizes the disk subsystem and validates an I/O request to access the disk subsystem sent by the first host system to the virtualization engine; wherein the virtualization engine determines whether the second host system cache comprises data to fulfill the I/O request; wherein, if the I/O request is validated and the second host system cache comprises data to fulfill the I/O request, the virtualization engine sends instructions to the second host system to complete the I/O request with the virtualization engine; and wherein the virtualization engine transfers the completed I/O request to the first host system.

### BRIEF DESCRIPTION OF THE DRAWINGS

The invention may be understood by reference to the following description taken in conjunction with the accompanying drawings, in which like reference numerals identify like elements, and in which:

FIG. 1 depicts a typical prior art configuration of a virtualization engine system;

FIG. 2 depicts a novel configuration of a distributed shared memory system used for cache extension, in accordance with one embodiment of the present invention

FIG. 3 depicts a novel configuration of the virtualization engine system of FIG. 1, in accordance with one embodiment of the present invention; and

FIG. 4 depicts a novel configuration of the distributed shared memory system used for cache extension in FIG. 2, in accordance with one embodiment of the present invention.

### DETAILED DESCRIPTION OF PREFERRED EMBODIMENTS

Illustrative embodiments of the invention are described below. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims. It should be understood that the systems and methods described herein may be implemented in various forms of hardware, software, firmware, or a combination thereof.

Consider a virtualization engine (“VE”) with a processor and a memory (hereinafter referred to as “VE processor” and “VE memory,” respectively). For convenience, we describe this as a single VE system. However, it is understood that the VE may be implemented as a cluster of nodes, thereby providing fault tolerance. Each node may include one or more processors, a memory, I/O adapters and a power supply. The cluster of nodes should be able to run independently in the event of failover. The VE is operatively connected between a host system (“HS”) and a disk subsystem (“disk”). The HS may comprise a processor and memory (hereinafter referred to as “HS processor” and “HS memory,” respectively). The disk subsystem may comprise a processor for accepting and executing instructions from the VE.

In prior art designs, all I/O is generally performed via the VE. That is, to transfer data to/from the HS from/to the disk, the data must flow through the VE. The prior art designs handle exemplary I/O commands as follows.

a) Read request: A read request comprises a request for data and an address location. Read requests are sent to the VE. The VE verifies whether the HS has permission to read from the address location on the disk. If so, the VE attempts to find the requested data on the disk. The VE first checks the VE memory for the requested data. If the requested data is not cached in the VE memory, the requested data is fetched from the disk, cached in the VE memory, and sent to the HS.

b) Write request: A write request comprises an address location and data to be written to the disk. The VE verifies whether the HS has permission to write to the address location on the disk. If so, the data to be written to the disk is sent to the VE, along with the address location. The VE writes the data to the disk in the location specified by the address location. Prior to writing the data to the disk, the VE may copy the data to an alternate VE for fault tolerance. In this case, the data is typically not written to the disk until the second VE acknowledges receipt of the data.

The read and write requests described herein are exemplary and are limited only for the sake of simplicity. It is understood that any of a variety of I/O commands and requests may be utilized in a VE system as contemplated by those skilled in the art. For example, the VE system may perform a storage allocation request for allocating storage space on the disk and retrieving a physical and virtual address. It is further understood that the VE may utilize an I/O queue for handling a plurality of I/O commands and requests.

In the present invention, we separate the control functions of the I/O from the actual caching and transfer of data. This is referred herein as “disk improvements.” For caching, this enables improved utilization of bandwidth and memory. For transfers of data, bandwidth is improved while retaining security.

Also in the present invention, we utilize unused portions of other host systems to serve as a cache. This is referred herein as “cache enhancements.”

A. Disk Improvements

a) Read request: As previously stated, a read request comprises a request for data and an address location. The read request is sent by the HS to the VE. The VE verifies that the HS can read from the address location of the disk. If so, the VE translates the virtual address to a physical address, and initiates and directs the transfer of data to the HS directly from the disk, thereby entirely avoiding transferring through the VE. It is understood that if the requested data is located in the disk cache or in the VE cache, the disk cache or VE cache, respectively, may transfer the requested data directly to the HS without accessing the disk.

b) Write request: As previously stated, a write request comprises an address location and data to be written to the disk. The HS sends a write request to the VE. The VE verifies that the HS can write to the address location of the disk. The VE initiates and directs the transfer of data from the HS directly to the disk, thereby entirely avoiding transferring through the VE. It is understood that data may be written to the disk cache in addition to being written on the address location of the disk.

An advantage of the present design, in addition to the potentially more efficient use of bandwidth and memory, is that the HS systems do not directly control I/O. As shown above, this is done remotely under control of the VE, retaining security even though data transfers directly between the host and the disk.

It is understood that in alternate embodiments, on a write request, the HS may send the data to be written to the VE. In this case, the VE may cache the data in the VE cache, and then write the data to the disk. However, in such an embodiment, the read requests would still involve the transfer of data to the HS directly from the disk. Because read requests are generally more frequent than write requests, the efficiency improvement is still quite substantial.

B. Cache Enhancements

a) Read request: The read request is sent by a first HS to the VE. The VE verifies that the first HS can read from the address location of the disk. If so, the VE translates the virtual address to a physical address. Prior to accessing the disk, the VE checks an extended cache for the requested data. The term “extended cache,” as used herein, refers specifically to unused memory in other HSs. It is understood that a “cache enhancements” system may comprise any number of extended caches on any number of other HSs, as contemplated by those skilled in the art. If the requested data is present on the extended cache, the VE initiates and directs the transfer of data to the HS directly from the extended cache, thereby entirely avoiding transferring through the VE. It is further understood that prior to accessing the extended cache, the VE may check whether the requested data is in the VE cache. If the requested data is not in the VE cache, the VE notifies an extended cache about the read request.

It is understood that parts A (i.e., disk improvements) and B (i.e., cache enhancements) may be combined and utilized in combination. For example, if the requested data is not found in the VE cache or the extended cache of part B, the VE may access the disk cache and disk of part A to retrieve the requested data.

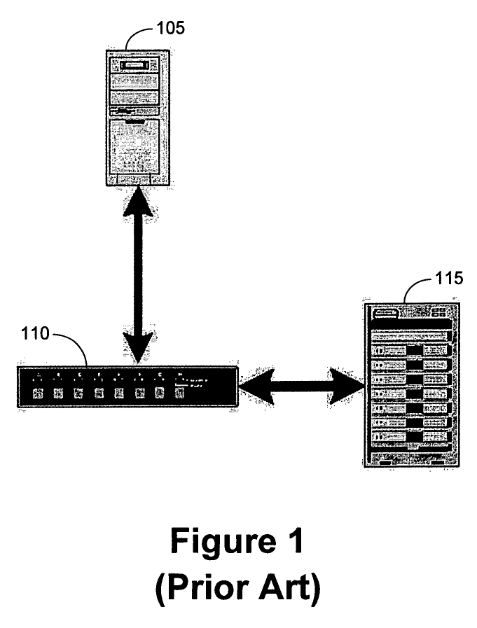

We now describe the VE system introduced above with reference to FIGS. 1-4.

Referring now to FIG. 1, a typical prior art configuration of a VE without disk improvements is shown. A HS 105 sends a I/O request to a VE 110. The VE 210 verifies that the HS 105 has permission to perform the I/O request on a disk 115. If so, the VE 110 translates the virtual disk address to a physical disk address that is used to complete the I/O request. The VE 110 performs the I/O request with the disk 115.

For an exemplary read operation, the VE 110 will retrieve the requested data from the VE cache and send it directly to the HS 105. If the data is not in the VE cache, the VE 110 may first send the read request to the disk cache (not shown) of the disk 115. If the requested data is not in the disk cache, the VE 110 may send the read request to the disk 115, and the disk 115 transfers the requested data to the VE 110. The VE 110 transfers the requested data to HS 105.

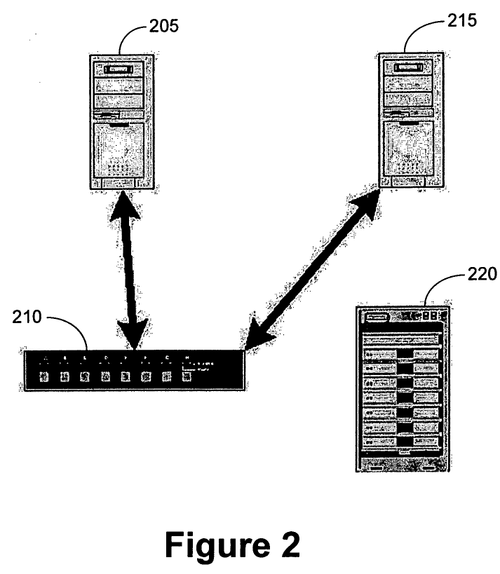

Referring now to FIG. 2, a novel configuration of a VE without cache enhancements is shown, in accordance with one embodiment of the present invention. A first HS 205 makes a read request to a VE 210. The VE 210 verifies whether the HS 205 has permission to perform the read request on disk 220 at the address location specified by the read request. If so, the VE 210 checks whether the requested data is already cached in a second HS 215. If the requested data is cached in the second HS 215, the VE 210 instructs the second HS 215 to transfer the requested data. The VE 210 caches the requested data in the VE cache (not shown), and sends the requested data to the first HS 205.

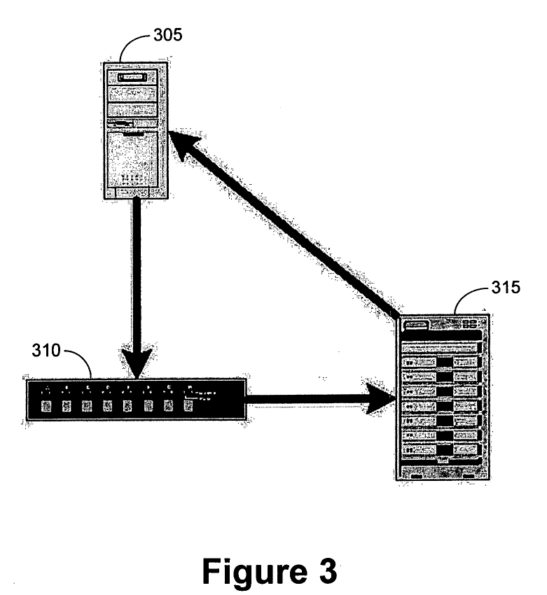

Referring now to FIG. 3, a VE configuration with disk improvements is shown, in accordance with one embodiment of the present invention. FIG. 3 illustrates a split between I/O control functions and the transfer of data, as opposed to FIG. 1. An HS 305 sends an I/O request to the VE 310. The VE 310 verifies that the HS 305 has permission to perform the I/O request on a disk 315. If so, the VE 310 translates the virtual I/O address to a physical address.

For an exemplary read operation, the VE 310 instructs the disk 315 to transfer the requested data directly to the HS 305, thereby entirely avoiding transferring the requested data to the VE 310. The instructions sent from the HS 305 to the VE 310 and the VE 310 to the disk 315 may comprise Internet Small Computer System Interface (“iSCSI”) commands, or any of a variety of fibre channel commands, as contemplated by those skilled in the art.

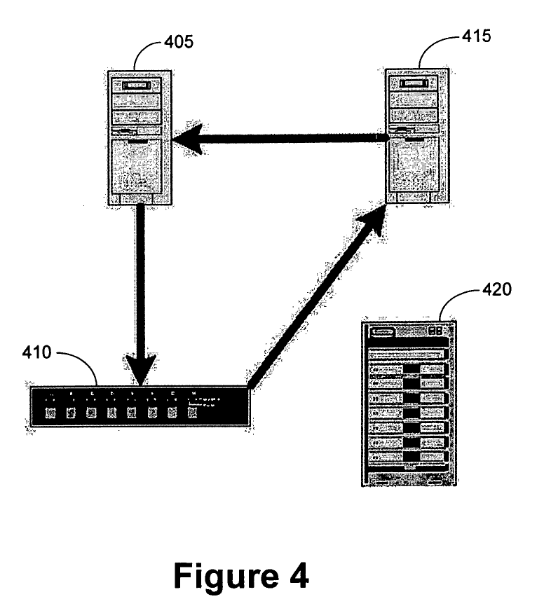

Referring now to FIG. 4, a VE configuration with cache enhancements is shown, in accordance with one embodiment of the present invention. FIG. 4 illustrates a split between I/O control functions and the transfer of data, as opposed to FIG. 2. A first HS 405 makes a read request to a VE 410. The VE 410 verifies whether the HS 405 has permission to perform the read request on disk 420 at the address location specified by the read request. If so, the VE 410 sends control information to a second HS 415 to complete the read request. The second HS 415 reads the disk request directly with the first HS 405, thereby bypassing the VE 410 entirely.

Separating request and control functions from data transfer may be achieved by, for example, changing fibre channel drivers and modifying the low level software of the HS, the VE, and the disk. More specifically, the HS may be required to login to both the VE and the disk. Also the HS may be required to accept data from either the VE or the disk, in response to a I/O request, for example, a read request. Likewise, the disk may be required to provide data to either the VE or the HS, upon the I/O request The I/O request may include additional information about the destination as well. Further, the VE may be required to either send data from its cache to the HS, or forward a modified I/O request to the disk.

The system improvements and modifications provided by the present invention may also have a wider application than just to the VE case. For example, certain features described above can be used to enhance the security of distributed storage systems, as the control of transfers is separated from the requests in a manner which permits such control to be encapsulated in a secure component.

The particular embodiments disclosed above are illustrative only, as the invention may be modified and practiced in different but equivalent manners apparent to those skilled in the art having the benefit of the teachings herein. Furthermore, no limitations are intended to the details of design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A distributed storage system for caching, comprising:
a host system;
a virtualization engine operatively connected to the host system; and
a disk subsystem operatively connected to the virtualization engine and the host system;
wherein the virtualization engine virtualizes the disk subsystem and validates a request to access the disk subsystem sent by the host system to the virtualization engine; and
wherein, if the request is validated, the virtualization engine sends instructions to the disk subsystem to complete the request directly with the host system, bypassing the virtualization engine.

2. The distributed storage system of claim 1, wherein the virtualization engine validates a request to access the disk subsystem comprises the virtualization engine determines the host system has permission to access the disk subsystem as specified by the request.

3. The distributed storage system of claim 1, wherein the host system comprises a HS processor and a HS memory, the HS memory caching data transferred between the disk subsystem and the host system.

4. The distributed storage system of claim 1, wherein the virtualization engine comprises a VE processor and a VE memory.

5. The distributed storage system of claim 1, wherein the disk subsystem comprises a disk processor.

6. The distributed storage system of claim 1, wherein the disk subsystem comprises a disk cache and a disk storage, the disk cache caching data transferred between the disk storage and the host system.

7. The distributed storage system of claim 1, wherein the request comprises an I/O request.

8. The distributed storage system of claim 7, wherein the I/O request comprises one of a read request and a write request.

9. The distributed storage system of claim 7, wherein the I/O request comprises an I/O command.

10. The distributed storage system of claim 7, wherein the I/O request comprises an I/O command and an address location in the disk subsystem in which to execute the I/O command.

11. The distributed storage system of claim 10, wherein the address location is a virtual address location.

12. The distributed storage system of claim 11, wherein the virtualization engine translates the virtual address location to a physical address location.

13. The distributed storage system of claim 1, wherein the requests sent by the host system to the virtualization engine comprises iSCSI commands.

14. The distributed storage system of claim 1, wherein the instructions sent by the virtualization engine to the disk subsystem comprises iSCSI commands.

15. The distributed storage system of claim 1, wherein the virtualization engine further comprises a queue for handling a plurality of requests to access the disk subsystem.

16. A distributed storage system for caching, comprising:
a first host system;
a second host system, the second host system comprising a second host system cache;
a virtualization engine operatively connected to the first host system and the second host system; and
a disk subsystem operatively connected to the virtualization engine, the first host system, and the second host system;
wherein the virtualization engine virtualizes the disk subsystem and validates an I/O request to access the disk subsystem sent by the first host system to the virtualization engine;
wherein the virtualization engine determines whether the second host system cache comprises data to fulfill the I/O request; and
wherein, if the I/O request is validated and the second host system cache comprises data to fulfill the I/O request, the virtualization engine sends instructions to the second host system to complete the I/O request directly with the first host system, bypassing the virtualization engine.

17. The distributed storage system for caching of claim 16, wherein the second host system cache comprises a portion of memory unused by the second host system.

18. The distributed storage system for caching of claim 16, wherein the I/O request comprises an address location of the disk subsystem and an I/O command to be executed at the address location of the disk subsystem.

19. The distributed storage system for caching of claim 18, wherein the virtualization engine validates an I/O request to access the disk subsystem comprises the virtualization engine determines the host system has permission to perform the I/O command at the address location of the disk subsystem.

20. The distributed storage system for caching of claim 16, wherein the virtualization engine further comprises a virtualization engine cache; and
wherein, if the request is validated and the virtualization engine cache comprises data to fulfill the I/O request, the virtualization engine completes the I/O request directly with the first host system, bypassing sending instructions to the second host system.

21. The distributed storage system of claim 16, wherein the I/O request comprises one of a read request and a write request.

22. The distributed storage system of claim 16, wherein the I/O request comprises an I/O command.

23. The distributed storage system of claim 16, wherein the I/O request comprises an I/O command and an address location in the disk subsystem in which to execute the I/O command.

24. The distributed storage system of claim 23, wherein the address location is a virtual address location.

25. The distributed storage system of claim 24, wherein the virtualization engine translates the virtual address location to a physical address location.

26. The distributed storage system of claim 16, wherein the I/O requests sent by the host system to the virtualization engine comprises iSCSI commands.

27. The distributed storage system of claim 16, wherein the instructions sent by the virtualization engine to the disk subsystem comprises iSCSI commands.

28. The distributed storage system of claim 16, wherein the virtualization engine further comprises a I/O queue for handling a plurality of requests to access the disk subsystem.

29. The distributed storage system of claim 16, wherein the host system comprises a first host system cache for caching data transferred between the second host system and the first host system.

30. A distributed storage system for caching, comprising:
a host system;
a virtualization engine operatively connected to the host system, the virtualization engine comprising a virtualization engine cache; and
a disk subsystem operatively connected to the virtualization engine and the host system;
wherein the virtualization engine virtualizes the disk subsystem and validates an I/O request to access the disk subsystem sent by the host system to the virtualization engine, the I/O request comprising a read request;
wherein, if the read request is validated and requested data is found in a virtualization engine cache, the virtualization engine cache transfers the requested data directly to the host system; and
wherein, if the read request is validated and the requested data is absent in the virtualization engine cache, the virtualization engine sends instructions to the disk subsystem to transfer the requested data directly to the host system, bypassing the virtualization engine.

31. The distributed storage system for caching of claim 30,
wherein the I/O request further comprises a write request; and
wherein, if the write request is validated, the virtualization engine sends instructions to the disk subsystem to transfer requested data to the virtualization engine, the virtualization engine caches the requested data in a virtualization engine cache, and the virtualization engine writes the requested data to the disk subsystem.

32. A distributed storage system for caching, comprising:
a first host system;
a second host system, the second host system comprising a second host system cache;
a virtualization engine operatively connected to the first host system and the second host system; and
a disk subsystem operatively connected to the virtualization engine, the first host system, and the second host system;
wherein the virtualization engine virtualizes the disk subsystem and validates an I/O request to access the disk subsystem sent by the first host system to the virtualization engine;
wherein the virtualization engine determines whether the second host system cache comprises data to fulfill the I/O request;
wherein, if the I/O request is validated and the second host system cache comprises data to fulfill the I/O request, the virtualization engine sends instructions to the second host system to complete the I/O request with the virtualization engine; and
wherein the virtualization engine transfers the completed I/O request to the first host system.

33. The distributed storage system for caching of claim 32, wherein the second host system cache comprises a portion of memory unused by the second host system.

34. The distributed storage system for caching of claim 32, wherein the I/O request comprises an address location of the disk subsystem and an I/O command to be executed at the address location of the disk subsystem.

35. The distributed storage system for caching of claim 34, wherein the virtualization engine validates an I/O request to access the disk subsystem comprises the virtualization engine determines the host system has permission to perform the I/O command at the address location of the disk subsystem.

36. The distributed storage system for caching of claim 32,
wherein the virtualization engine further comprises a virtualization engine cache; and
wherein, if the request is validated and the virtualization engine cache comprises data to fulfill the I/O request, the virtualization engine completes the I/O request directly with the first host system, bypassing sending instructions to the second host system.

37. The distributed storage system for caching of claim 32,
wherein the virtualization engine further comprises a virtualization engine cache; and
wherein, the virtualization engine stores the completed I/O request in the virtualization engine cache prior to transferring the completed I/O request to the first host system.

38. The distributed storage system of claim 32, wherein the I/O request comprises one of a read request and a write request.

39. The distributed storage system of claim 32, wherein the I/O request comprises an I/O command.

40. The distributed storage system of claim 32, wherein the I/O request comprises an I/O command and an address location in the disk subsystem in which to execute the I/O command.

41. The distributed storage system of claim 40, wherein the address location is a virtual address location.

42. The distributed storage system of claim 41, wherein the virtualization engine translates the virtual address location to a physical address location.

43. The distributed storage system of claim 32, wherein the I/O requests sent by the host system to the virtualization engine comprises iSCSI commands.

44. The distributed storage system of claim 32, wherein the instructions sent by the virtualization engine to the disk subsystem comprises iSCSI commands.

45. The distributed storage system of claim 32, wherein the virtualization engine further comprises a I/O queue for handling a plurality of requests to access the disk subsystem.

46. The distributed storage system of claim 32, wherein the host system comprises a first host system cache for caching data transferred between the virtualization engine and the first host system.
